(19) United States
(12) Patent Application Publication
(10) Pub. No.: US 2010/0169159 A1
(43) Pub. Date: Jul. 1, 2010

(54) Media for Service and Marketing

(76) Inventors: Nicholas Rose, San Francisco, CA (US); Lap Chan, Daly City, CA (US); Qin He, San Jose, CA (US); Ashish Kothari, Cupertino, CA (US); Guatam Dharamshi, Sunnyvale, CA (US); Narendra Penagulur, Sunnyvale, CA (US)

Correspondence Address: FISH & RICHARDSON, P.C., PO BOX 1022, MINNEAPOLIS, MN, 55440-1022, US

(21) Appl. No.: 12/346,715

(22) Filed: Dec. 30, 2008

(51) Int. Cl. G06Q 10/00; G06Q 99/00; G06F 3/048

(52) U.S. Cl. 705/10; 715/760; 705/306

(57) ABSTRACT

Methods, systems, and computer program products for performing the method are provided. The method includes receiving in a customer relationship management (CRM) application, data from a communication made by a first person using a social interaction application that allows third party access to communications. The method also includes assigning based on the data, a sentiment indicator to the communication according to a predefined scale and generating at least one output to the first person using the CRM application in response to receiving the data, the output based on the sentiment indicator.

### TECHNICAL FIELD

This document relates to the integration of a social interaction application with a customer relation management application.

### BACKGROUND

Computer systems often are used to manage and process business data, and manage the relationship between a business enterprise and its customers. To do so, a business enterprise may use various customer relationship management applications running on one or more enterprise IT systems. Customer relationship management application programs may be used to process customer related transactions, such as organizing, planning, operating procedures, management, allocation of resources with respect to customers. A computer system may include a social interaction application system that is a social media system where customers exchange conversations, communications within which they express their sentiments with regards to a particular business enterprise.

### SUMMARY

The invention relates to a social interaction application integrated with a customer relation management application.

In one general aspect, a customer relationship management (CRM) application receives data from a communication made by a first person using a social interaction application that allows third party access to communications. A sentiment indicator is assigned to the communication based on the data according to a predefined scale. In response to receiving the data, at least one output is generated to the first person using the CRM application, the output based on the sentiment indicator.

Implementations may include one or more of the following features. The data may comprise a user identity associated with the first person in the social interaction application, a date and time of the communication, a content of the communication and a location associated with the first person. The CRM application may display in graphical user interface information about the first person that existed in the CRM application before the data was received, the information selected using the user identity. The CRM application may display in graphical user interface the sentiment indicator and the data using filters that screen the sentiment indicator and the data according to predefined filtering rules.

Before generating the output, a determination may be made based on the user identity in the social interaction application as to whether the first person has a customer identity in the CRM application. In response to the determination that the first person has no customer identity in the CRM application, a customer identity may be associated with the first person in the CRM application. The output may include a request to the first person for consent to map the user identity in the social interaction application with the customer identity in the CRM application. The consent may be received from the first person. In response to the consent, the user identity in the social interaction application may be used to communicate with the first person from the CRM application.

A service ticket may be created based on the data. The output may include information associated with the creation of the service, and the output may be visible only to the first person in the social interaction application. The output may also be broadcast in the social interaction application.

The communication may be related to a predetermined business and may have been made over a predetermined period of time. In the CRM, more data from one or more other communications made by one or more other persons in the social interaction application may be received. Each of the other communications may be related to the predetermined business and may have been made over the predetermined period of time. A respective sentiment indicator may be assigned based on the more data to each of the other communications accordingly the predetermined scale. A sentiment index for the predetermined business may be determined using the sentiment indicator and each respective sentiment indicator.

The received data may be from an application programming interface (API) of the social interaction application. The received data may be in one of the following forms: (a) Extensible Mark-up Language (XML); (b) Atom format; and (c) JSON format. The sentiment indicator may be associated with sentiment values comprising strong value, weak positive, neutral, weak negative and strong negative. The output may include a selectable link to a web site associated with a promotion. A display device may generate a visual display that shows visual representations of data relative to the first person selecting the link in response to the output.

Implementations can include one or more of the following advantages. Customer interaction regarding a particular product or service can be noticed in a timely way. Customer sentiment regarding a product or service can be detected and directly applied to opening a service ticket or other communication. A vendor's customer relationships can be improved due to a more direct interaction.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of an example network of computer systems.

FIG. 2 is a flow chart of an example process for creating a customer service ticket for a user in response to a communication made by the user in a social media system.

FIG. 3 is a flow chart of an example process for monitoring the sentiment of multiple communications made in a social media system.

FIG. 4A is illustration of an example graphical user interface that may be used to reply, direct reply, or create a service ticket for a user of a social media system.

FIG. 4B is illustration of an example graphical user interface that may be used to monitor the sentiment index of multiple communications made within a social media system.

FIG. 5 is a block diagram of a computing system that can be used in connection with computer-implemented methods described in this document.

Like reference symbols in the various drawings indicate like elements.

### DETAILED DESCRIPTION

To illustrate the techniques presented in this description, examples of the challenges and issues related to integrating customer relationship management (CRM) system of a business enterprise with a third party social media system are discussed. An enterprise resource planning system may include a CRM processing component that enables a creation of a service ticket for a customer or other customer service transactions. Creation of a service ticket for customers of a business enterprise may require the business enterprise to be aware of any issues concerning its product or service in a timely fashion. When the business enterprise is not timely aware of issues concerning its products or services, the sentiments of the business' customers towards the business enterprise may be affected and so are affected the customers' relationship with the business enterprise.

Integration of the CRM system with a third party social media system may allow the CRM system to improve its response time to a customer's issues by timely creating service tickets and communicating with the customer, and thus improving the customer's relationships. The integration may also allow the business enterprise to monitor multiple communications made in the social media about the business enterprise's products and services, thus the business enterprise may see based on the communications how well the business enterprise is operating.

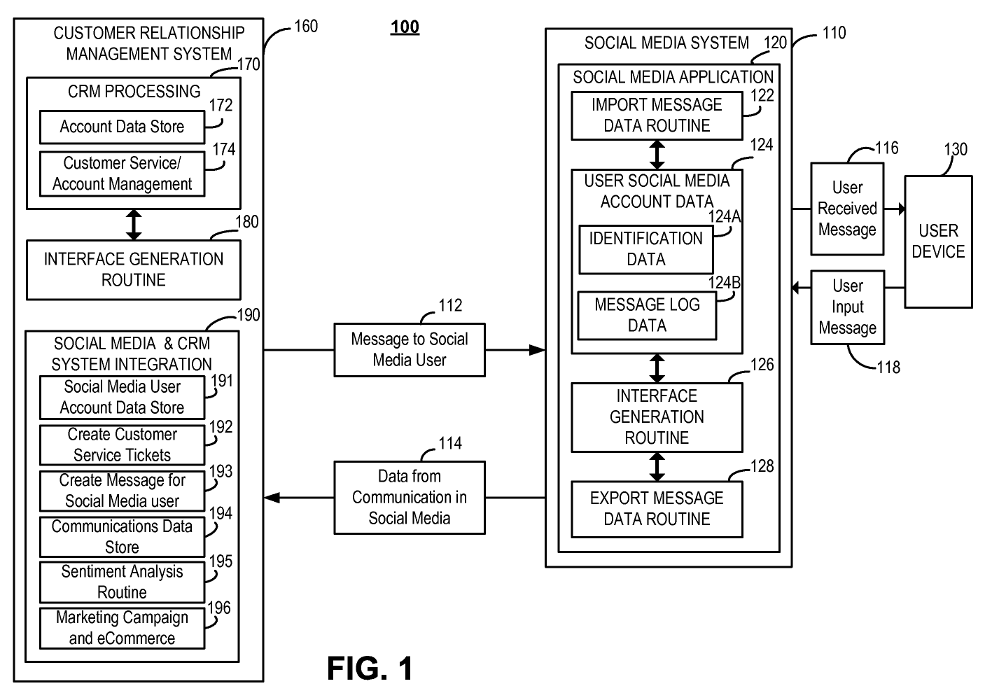

FIG. 1 is a block diagram of an example system 100 where a social media system 110 is integrated with a customer relationship management (CRM) system 160 for a business enterprise. The social media system 110 may be a socially interactive application, such as Twitter that can allow third parties to see, listen or monitor conversations. A user of the CRM system 160 may be, for example, a representative of the business enterprise that uses the CRM system 160 to monitor communications, conversations in the social media system 110 about a predefined topic. For example, the topic may be the business enterprise's products or services. As shown, in one implementation, the system 100 includes at least one user device 180. The user device allows a user of the social media system 110 to send a message in the social media system 110 using user input message 118 and to receive a message from the social media system 110 using user received message 116.

In some implementations, the social media system 110 can include any or all of multiple available social media systems. For example, the social media system 110 may be an internet based social media, such as Twitter, Facebook connect, Consumer Reports.org, or ServiceRatings.org. The social media system 110 includes a social media application 120. The social media application 120 includes an import message data routine 122. The import message data routine 122 imports data that the CRM system 160 sends to the social media system 110 using message 112. The import message data routine 122 also imports the user input message 118.

In some implementation, the message 112 sent by the CRM system 160 to the social media system 110 and imported in the social media system 110 using import message data routine 122 may be visible to anyone using the social media system 110. In another implementation, the message 112 is only visible to the user to whom the message is addressed.

The social media application 120 also includes a user social media account data 124, which includes information about a user's account on the social media system 110. User social media account 124, as shown in this example, includes identification data 124A, and message log data 124B. The identification data 124A keeps record of account-holder identification information while message log data 124 keeps records of the account holder messages received within and sent out of the social media system 110.

In addition, the social media application 120 includes an interface generation routine 126. The interface generation routine 126 includes instructions that, when executed, display and control an interface that enables information related to the user's account on the social media system 110 to be presented to the user of the CRM system 120. The interface may be displayed within the CRM system 160.

The social media application 120 may also include an export message data routine 128. The export message data routine 128 includes instructions that when executed, export data from the communications in the social media system 110 to the CRM system 160 using data from communication in social media component 154. These instructions also when executed send data to the user device 130 using the user received message 116. Data exported to the CRM system 160 from the social media system 110 by the export message data routine 128 may include for example, a user identity in the social media system 110 associated with the exported communication, a date and time of the communication, a content of the communication and a location associated with the person that sent the communication in the social media system 110.

In some implementations, the information in data 114 provided to the CRM system 160, may come from an application programming interface (API) of the social media system 110. In another implementation, the information included in data 114 may be in one of multiple available forms. For example, the information included in data 114 may be in Extensible Mark-up Language (XML), Atom format, or JSON format.

Communications between the CRM system 160 and the social media system 110 as well as communications between the social media system 110 and the user device 130 may be provided, for example, through a variety of established networks, such as, for example, the internet, a Public Switched Telephone Network (PSTN), the Worldwide Web (WWW), a wide-area network (“WAN”), a local area network (“LAN”), a wired network, or a wireless network. The communications may also be provided through the use of a middleware messaging system. The CRM system 160 may exchange data with the social media system 110 through a communication gateway. For example, the message 114 may be transferred from the social media system 110 to the CRM system 160 through a gateway. Similarly, the social media system 110 may deliver and exchange data with the user device 130 through a communication gateway.

The CRM system 160 here includes a CRM processing component 170 that is used to store, modify, and process data associated with customers, for example, customers of the business enterprise. For example, the business enterprise uses the CRM system 160 to manage its customers and any follow up to their transactions with the business enterprise. In one example, the CRM processing component 170 may be a commercial computer application that is developed and licensed (or sold) by a commercial software developer for sale to, and use by, many business enterprises. In another example, the CRM processing component 170 and the social media & CRM system integration component 190 may be part of a suite of commercial applications that are developed and licensed (or sold) by a commercial software developer.

The CRM processing component 170 includes an account data store 172. In particular, the account data store 172 includes information about customers and their respective transactions with the business enterprise. Information about the customers may include, for example, the identity of a particular customer, the physical address of the particular customer, his mailing address, his account number and the opening date of the account. Information about customer respective transactions may include, for example, records of all transactions made by a customer with the business; records of all customer service follow up made for the particular customer.

The CRM processing component 170 also includes a customer service/account management component 174. The customer service/account management component 174 includes instructions that, when executed, enable a user of the CRM system 160 to manage a customer's account, for example, create a customer service ticket for the customer. In some implementations, the account management 174 after receiving information in data 114 that includes the user identity in the social media system 110 makes first a determination based on the user identity whether the user in the social media system 110 has a customer identity in the CRM system 160. If the user in the social media system 110 does not have a customary identity, the account management 174 will associate a customary identity with the user in the CRM system 160. In another implementation, the management account 174 includes instructions that when executed, enable the user of the CRM system 160 to select the social media system 110 from multiple available social media systems.

In some implementations, the message 112 may include a request from the CRM system 160 to the user in the social media system 110 for consent to map the user identity in the social media system 110 with a customer identity in the CRM system 160. The management component 174 may include instructions to map the user identity in the social media system 110 with a customer identity in the CRM system if the user gives his consent. This will allow, for example, the representative of the business to communicate with the user in the social media system 110 from the CRM system 160.

The CRM processing component 170 also may include instructions that, when executed, cause an interface generation routine 180 to display information stored in the account data store 172. For example, executing the instructions in the management component 174 may cause the interface generation routine 180 to display some or all of the transactions of a customer. In another example, executing the instructions may cause the interface generation routine 180 to display all the transactions of multiple customers. Yet, in another implementation, after the CRM system 160 received data 114 from a communication made by a user in the social media system 110, the interface generation routine 180 may display information about the user that may have existed in the CRM system before the user sent his communication in the social media system 110.

The interface generation routine 180 also includes instructions that, when executed, cause communications in the social media system 110 to be displayed in the CRM system 160 while they are taking place in the social media system 110. In some implementations, these communications in the social media system 110 may be addressed directly to a predefined account in the social media system 110. The predefined account may be, for example, an account associated with the business enterprise. In another implementation, these communications displayed by the interface generation routine 180 may be communications, conversations in the social media system 110 about a predefined topic. The topic may be for example, the business enterprise's products or services. Yet, in another implementation, the interface generation routine may display communications stored in the CRM system 160 that were addressed to the business enterprise in the social media system 110 or communications about the business enterprise made in the social media system 110 over a predetermined period of time.

In some implementations, the interface generation routine 180 enables a representative of a business enterprise to monitor the communications about the business enterprise in the social media system 110. For example, the interface 180 may show the communications and the identities of the users of the social media system 110 associated with those communications.

The CRM system 160 may also include a social media & CRM system integration component 190. The integration component 190 may be configured to receive data from communications made by users of the social media system 110, using the data 114. The integration component 190 enables customer related transaction such as customer service ticket creation defined in the CRM system 160 to be initiated for a user of the social media system 110. This allows the social media system 110 and the CRM system 160 to be used together.

The integration component 190 also includes a social media user account data store 191 that stores information about users of the social media system 110. In particular, the account data store 191 may store information about users of the social media system 110 who are associated with the business enterprise. This information may include, for example, a user identity in the social media system 110, and data about the mapping of the user identity in the social media system with a customer identity in the CRM system 160 if the user has a customer identity in the CRM system 160.

The integration component 190 also includes a create customer service tickets component 192. The create customer service tickets component 192 includes instructions that, when executed, allows customer service ticket to be created in the CRM system 160 for a particular user of the social media system 110. The create customer service tickets component 192 may allow the business representative to directly specify information that identify the user of the social media for whom the customer service ticket is created. In some implementations, for example, the representative may have the option to specify the service team and employee of the business enterprise responsible for servicing the service ticket. The create customer service tickets 192 may also have the option to determine which priority to give to the service ticket.

The integration component 190 also includes a create message for social user component 193. The create message component 193 includes instructions that, when executed, create the message 112 for a user in the social media system 110. In some implementations, the message 112 may include information associated with the creation of a service ticket for the user. For example, the message 112 may include information such as, when the service ticket was created, when to expect the related service to be executed, and the service team and employee who will be executing the service.

The integration component 190 also includes a communication data store 194 that stores communications received from the social media system 110 using data 114. These communications may be stored for a predetermined period of time.

The integration component 190 includes a sentiment analysis routine 195. The sentiment analysis routine 195 can access communications stored in the communications data store 194. In some implementation, the sentiment analysis routine 195 may access communications from a particular user. In another implementation, the communications can be from multiple users. The sentiment analysis routine 195 may associate a sentiment indicator of sentiment values to each communication received. The sentiment analysis routine 195 can determine the sentiment of a communication by parsing a written communication and comparing the words in the communication with a predefined database of words associated with predefined sentiment levels. For example, words such as awesome, good or great may receive positive sentiment. Another example, words such as bad, poor or pathetic may receive negative sentiment. The representative of the business enterprise when using the CRM system 160 may configure the system to interpret the sentiment of a communication in various ways. For example, the integration component 190 may be configured to interpret the sentiment of a communication as ranging from strong negative, to weak negative, neutral, weak positive, and strong positive.

In addition, the sentiment analysis routine 195 may include instructions that when executed cause to filter the communications from the social media system 110 displayed in the integration component 190 by the interface generation routine 180. For example, the representative of the business enterprise may choose to show only communications that contain particular term, for example the term hard drive, or lap top. The sentiment analysis routine 195 may assign the sentiment indicator to any communications displayed in the integration component 190. In some implementations, based on the sentiment indicator of a communication, the representative of the business may create a message to be delivered to the user of the social media system 110 associated with the communication, using create message for social media user component 193.

In another implementation, the sentiment analysis routine 195 may assign a sentiment indicator to each communication stored in the communication data store 194 over a predetermined period of time. The sentiment analysis routine 195 may also associate a sentiment index using the sentiment indicators of various communications stored in the communications data store 194. In another implementation, the sentiment analysis routine 195 may cause the interface generation routine 180 to display visual representations of the sentiment index of the communications from the social media system 110 related to a predetermined business. These communications may have been stored in the communications data store 194 over a predetermined period of time. For example, these communications may have been about the user of the CRM system 160's business enterprise over a predetermined period of time. The interface generation routine 180 may display the communications and their respective sentiment indicators according to predefined filtering rules. For example, the interface generation routine 180 may only display communications associated with strong negative sentiments and related to hard drive topic.

The integration component 190 also includes a marketing campaign and ecommerce component 196. The marketing campaign and ecommerce component 196 includes instructions that, when executed, create the message 112 for users in the social media system 110, where the message 112 includes a selectable link, such as a uniform resources locator (URL) that may allow users to access a web site. For example, the web site may be an e-commerce web site promoting a business enterprise's product or service. In some implementations, the interface generation routine 180 may display in the integration component 190 visual representations of data indicative of users traffic levels in, for example, the e-commerce web site in response to the message 112 that includes the selectable link to the particular e-commerce web site.

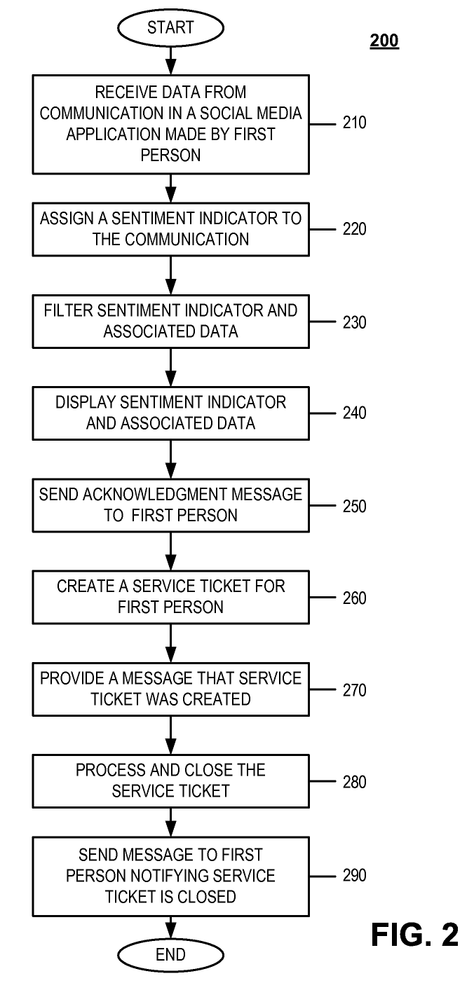

FIG. 2 depicts an example process 200 for providing customer service to customers who leverage social media systems to vent their frustration about a business enterprise's products or services. The process 200 may allow the business enterprise to monitor a communication from a user device such as the user device described with respect to FIG. 1. The process 200 may be performed by one or more processors in a system, such as, for example, the CRM system 160. The process is directed by a method, script, or other type of computer program that includes executable instructions for performing the process 200. The process 200 may be manually initiated by, for example, a customer service agent for a business or any other user of the CRM system 160 who wants to monitor the sentiment of the conversation about the business in a social media system such as the social media system 120 described with respect to FIG. 1, and provides a proactive customer service to customers based on the sentiment of the conversation.

The process 200 begins when a user of the CRM system 160 initiates the process 200, and the process receives data from a communication made by a person in a social media system, such as twitter (Step 210). The received data may comprise, for example, the person identity in the social media system, the date and time when the communication took place, the location of the person and the content of the communication. The process 200 continues when the processor assigns a sentiment indicator to the communication, based on the data, according to a predefined scale (step 220). The predefined scale may be configured by each particular business allowing the business to determine its own various ways to interpret the sentiment of a communication or a conversation. For example, the predefined scale of sentiment indicators can be configured to categorize sentiment as strong positive, weak positive, neutral, weak negative, and strong negative. Once the processor has assigned a sentiment indicator to the communication, the process 200 continues when the processor displays in a graphical user interface the communication, the sentiment indicator associated with the communication, the date and time when the communication was made along with a user identity of the person in the social media (step 230).

The process 200 continues when the processor filters communications to display communications based on associated sentiment indicators (step 240). For example, the processor may display only a communication associated with a strong negative sentiment indicator.

The process 200 continues when the processor displaying a communication from a particular person based on the sentiment indicator of the communication, the process sends an acknowledgement message to the person (step 250). For example, the person may have written complaining about a particular product of the business. The complaint may have led the processor to assign a negative sentiment indicator to the communication. The processor may select this communication and may send an acknowledgement to the person stating that the user of the CRM is aware of the issue concerning the person.

The process 200 continues when the processor creates a service ticket in the CRM system for the person using his user identity in the social media (step 260). The service ticket may be, for example, a repair ticket that will cause a customer service technician to call the person in order to solve the person's technical problem. The example process 200 also includes providing a message to the person stating that a service ticket has been created (step 270).

The process 200 continues when the processor actively processes the service ticket, and closes the service ticket once the issue related to the creation of the service ticket is resolved (step 280). For example, a technician of the business has been dispatched to resolve the issue raised by the person in the social media about the business's product, and the technician has resolved the issue. The process 200 continues when the processor sends a message to the person in the social media notifying the person that the service ticket is closed (step 290).

As illustrated by the process 200, a customer service agent for a business enterprise is able to use the process to provide a proactive customer service to customers who leverage social media to vent their frustration about the business's products or service.

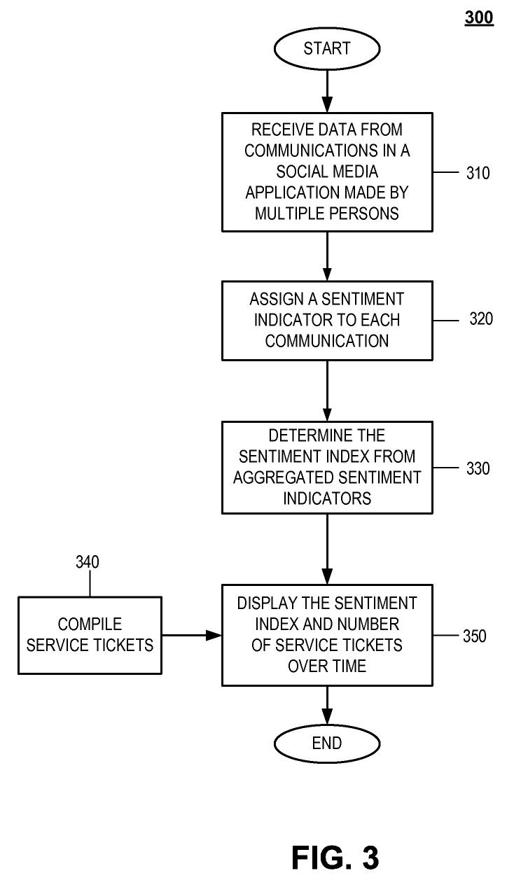

FIG. 3 depicts an example process 300 that allows a user of a system, such as the CRM system 160 described with respect to FIG. 1, to monitor all general conversation about a business enterprise in the social media system 110 of FIG. 1.

Similar to the process 200, the process 300 may be performed by one or more processors in a system, such as, for example, the CRM system 160. The processor is directed by a method, script, or other type of computer program that includes executable instructions for performing the process 300. The process 300 may be manually initiated by, for example, a customer service agent or any other user of the CRM system 160 who wants to monitor the sentiment of conversations about a business enterprise in a social media, for example, such as twitter. The customer service agent may want to search for any conversation about the business enterprise in the social media system.

The process 300 begins when the processor receives data from communications made by several persons over a predefined time period using a social interaction application that allows third party access to communications (310). The data may include for example, all the communications taking place about a particular company in the social media over a predefined time period. Each data from each person may include, for example, the user identity in the social interaction application, the date and time when the communication was made and the content of the communication.

The process 300 continues when the processor assigns a sentiment indicator to each communication (320). For example, a negative sentiment indicator may be assigned to a conversation in which a person expressed a disappointment with a business enterprise's products or service. The process 300 continues when the processor gathers the received communications based on their respective sentiment indicators, and determine a sentiment index for the communications from the aggregated sentiments indicators (330).

The process continues when the processor compile all the service tickets created by, for example the CRM system 160, over the predefined time period (340). For example, the processor may gather information about an increase in the number of service tickets due to issues with a technical support center that may have left the business enterprise unable to handle a product component recall effectively.

The process continues when the process displays over the predefined time period the sentiment index from step 330 and the compiled number of service tickets from step 340 in a graphical user interface, for example, a dashboard in the CRM system 160 (350). For example, the process can show how the sentiment index of conversations in the social media application 110 and the number of tickets created by the business enterprise has varied over the predefined time period. This process 300 may, for example, give the user of the CRM system a picture of how the business enterprise performed operationally during the predefined time period.

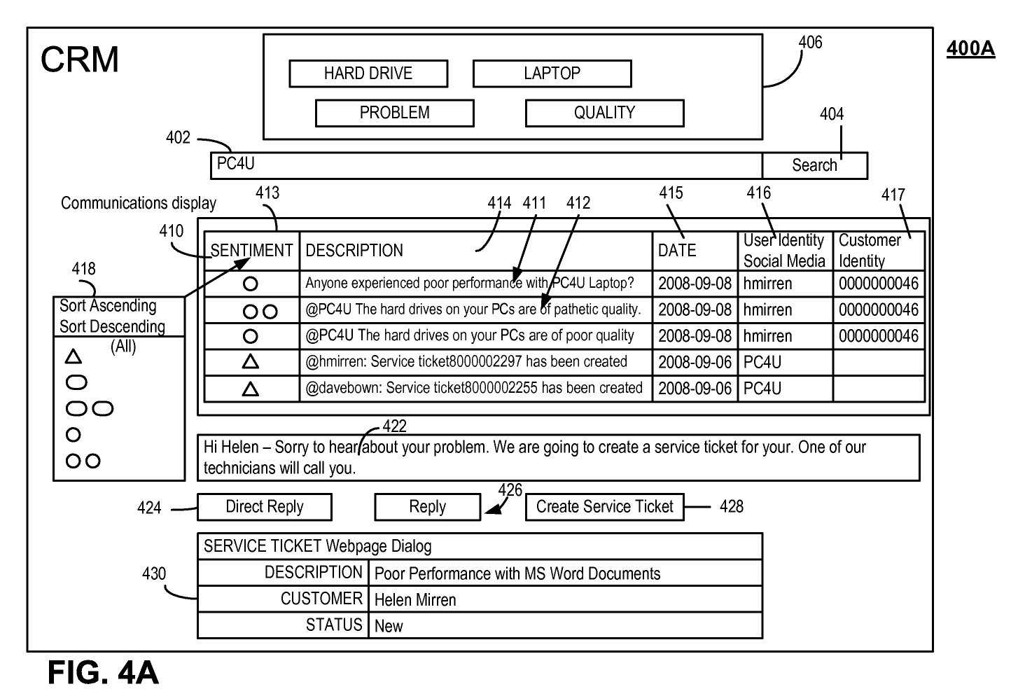

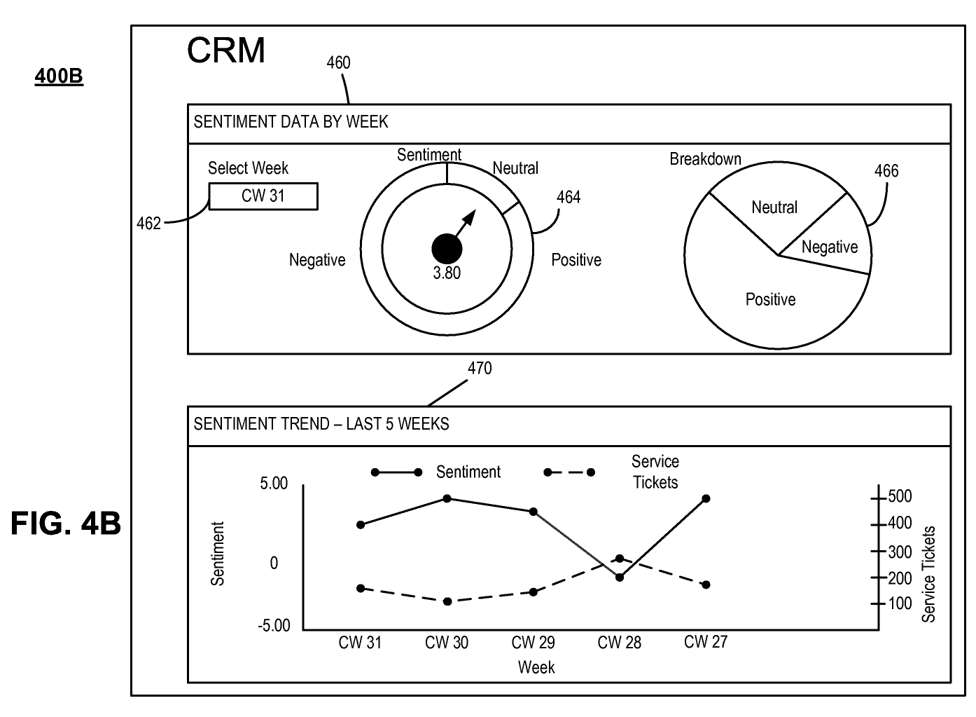

FIG. 4A is an illustration of an example graphical user interface 400A that may be used to provide a proactive customer service to a customer who has leveraged a social media to vent the customer's frustration about a product. In one implementation, the graphical user interface 400A may be accessible through a CRM system such as the CRM system 160 described above in the context of FIG. 1. In the example shown in FIG. 4A, the user has selected to provide a customer service to one named “Helen Mirren,” user of a social media such as the social media system 110 described above in the context of FIG. 1.

The graphical user interface 400A includes a search field 402 and a search submit button 404. The search field 402 enables the user of the CRM system to enter search terms, for example, such as “PC4U” and then search for communications in the social media that contain the defined search terms. In one implementation, after the user presses the search button 404, the GUI 400A will display all the communications from the social media system that contain, for example, the term “PC4U.”

The graphical user interface 400A also includes a filters tab 406 that allows to display, for example, only the communications that contain words such as “hard drive,” “lap top,” “problem,” or “quality.”

The graphical user interface 400A also includes a communications display 410 that displays, for example, the communications 411 and 412. The communications display 410 also enables to display the communications under display section sentiment 413, section description 414, section date 415, section user identify 416 and section customer identity 417. For the example illustration, the communication 411 may have under section sentiment 413 only one point sentiment indicator. The communication 411 may have displayed under section description 414, the content of the communication. As shown, under section date 415, the date “2008-09-08” is provided. Under section user identity 416, the user identity of Helen Mirren as “hmirren” in the social media system is provided. Under section customer identity 417, the customer identity of Helen Mirren in the CRM system 160, “0000000046” is displayed. The communications display 410 also enables to sort the communications displayed based on their sentiment indicators under section sentiment 413, using section sort communications 418.

The graphical user interface 400A also includes a dialog field 422 that allows the user of the interface 400A, to send a message out of the CRM system. In the example shown, the user makes contact with Helen Mirren and informs her that a service ticket will be created and a technician will contact her soon.

The graphical user interface 400A also includes a direct reply button 424 that allows, for example, the user to specify that the output message 422 is addressed directly to Helen Mirren and is not visible to other users in the social media system 110. As shown in the example illustration, the user may also choose to press a reply button 426 that will make the output message 422 visible, for example to all users in the social media system 110 described in the context of FIG. 1. The graphical user interface 400A also includes a create service ticket 428 that allows the user to create a service ticket. For example, the user may want to create a service ticket for Helen Mirren. As shown, the graphical user interfaces may include a service ticket webpage dialog 430 that allows the user to specify the information regarding the creation of the service ticket for Helen Mirren. In the example illustration, description section, customer section and status section in the service ticket dialog 430 are filled providing information about Helen Mirren, the status of the ticket as new, the name of the customer as Helen Mirren, and the description of the service ticket as “poor performance with MS Word Documents.”

FIG. 4B is an illustration of an example graphical user interface 400B that may be used to define the monitoring of the sentiment of communications or conversations about a company in a social media system. The graphical user interface 400B may be running on a CRM system such as the CRM system 160 described above in the context of FIG. 1.

The graphical user interface 400B includes a sentiment data by week display 460 that allows a user of the graphical user interface 400B to display visual representation of a sentiment index associated with communications over a predefined time period. In the example illustration, the user may choose in a select week field 462 the time period calendar week (CW) 31. As shown, a visual representation 462 displays a sentiment index 3.8 associated with the communications from a social media system where the sentiment index corresponds to a sentiment index in the “neutral range.” The sentiment data by week display 460 also includes a visual representation 466 that displays the sentiment index and the communications as a pie chart that shows the relative size of, for example, positive, negative, or neutral, communications in a set of communications received in the selected week CW 31.

The graphical user interface 400B also includes a sentiment trend display 470 that allows the user of the graphical user interface 400B to display the sentiment index and number of service tickets issued over a predefined time period. In the example illustration, the user may have chosen to display the evolution of the sentiment index for the last 5 weeks, from week CW 31 to CW 27 and the evolution of service tickets issued over the same time period. As shown in the example, the sentiment index has a dip in the sentiment corresponding to CW 28. As also shown, the dip in CW 28 corresponds to an increase in the number of service tickets issued.

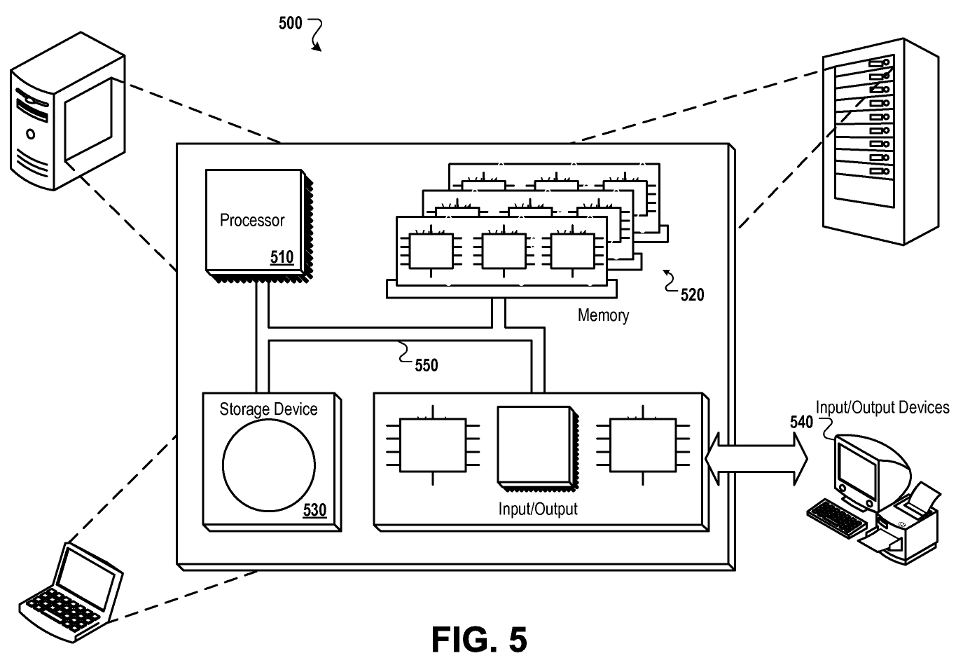

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for interacting with a customer, the method comprising:
receiving, in a customer relationship management (CRM) application, data from a communication made by a first person using a social interaction application that allows third party access to communications;
assigning, based on the data, a sentiment indicator to the communication according to a predefined scale; and
generating at least one output to the first person using the CRM application in response to receiving the data, the output based on the sentiment indicator.

2. The computer-implemented method of claim 1, wherein the data comprises a user identity associated with the first person in the social interaction application, a date and time of the communication, a content of the communication and a location associated with the first person.

3. The computer-implemented method of claim 2, wherein the CRM application displays in graphical user interface information about the first person that existed in the CRM application before the data was received, the information selected using the user identity.

4. The computer-implemented method of claim 1, wherein the CRM application displays in graphical user interface the sentiment indicator and the data using filters that screen the sentiment indicator and the data according to predefined filtering rules.

5. The computer-implemented method of claim 2, further comprising:
before generating the output, making a determination based on the user identity in the social interaction application as to whether the first person has a customer identity in the CRM application; and
in response to a determination that the first person has no customer identity in the CRM application, associating a customer identity with the first person in the CRM application.

6. The computer-implemented method of claim 2, wherein the output includes a request to the first person for consent to map the user identity in the social interaction application with the customer identity in the CRM application, the method further comprising:
receiving the consent from the first person; and
in response to the consent, using the user identity in the social interaction application to communicate with the first person from the CRM application.

7. The computer-implemented method of claim 1, further comprising:
creating a service ticket based on the data;
wherein the output includes information associated with the creation of the service ticket, and wherein the output is visible only to the first person in the social interaction application.

8. The computer-implemented method of claim 1, further comprising:
creating a service ticket based on the data;
wherein the output includes information associated with the creation of the service ticket, and wherein the output is broadcast in the social interaction application.

9. The computer-implemented method of claim 1, wherein the communication is related to a predetermined business and was made over a predetermined period of time, the method further comprising:
receiving, in the CRM, more data from one or more other communications made by one or more other persons in the social interaction application, wherein each of the other communications is related to the predetermined business and was made over the predetermined period of time;
assigning, based on the more data, respective sentiment indicator to each of the other communications accordingly to the predetermined scale;
determining a sentiment index for the predetermined business using the sentiment indicator and each respective sentiment indicator; and
generating on a display device, a visual display that shows visual representations of the sentiment index over the predetermined period of time.

10. The computer-implemented method of claim 1, wherein the received data is from an application programming interface (API) of the social interaction application.

11. The computer-implemented method of claim 1, wherein the received data is in one of the following forms: (a) Extensible Mark-up Language (XML); (b) Atom format; and (c) JSON format.

12. The computer-implemented method of claim 1, wherein the sentiment indicator is associated with sentiment values comprising strong value, weak positive, neutral, weak negative and strong negative

13. The computer-implemented method of claim 1, wherein the output includes a selectable link to a web site associated with a promotion, further comprises generating on a display device, a visual display that shows visual representations of data relative to the first person selecting the link in response to the output.

14. A computer program product tangibly embodied in a computer-readable storage device, the computer program product including instructions that, when executed, cause one or more data processing apparatus to perform operations for interacting with a customer, the operations comprising:
receiving, in a customer relationship management (CRM) application, data from a communication made by a first person using a social interaction application that allows third party access to communications;
assigning, based on the data, a sentiment indicator to the communication according to a predefined scale; and
generating at least one output to the first person using the CRM application in response to receiving the data, the output based on the sentiment indicator.

15. The computer program product of claim 14, wherein the data comprises a user identity associated with the first person in the social interaction application, a date and time of the communication, a content of the communication and a location associated with the first person.

16. The computer program product of claim 14, wherein the CRM application displays in graphical user interface the sentiment indicator and the data using filters that screen the sentiment indicator and the data according to predefined filtering rules.

17. The computer program product of claim 15, further comprising:
before generating the output, making a determination based on the user identity in the social interaction application as to whether the first person has a customer identity in the CRM application;
in response to a determination that the first person has no customer identity in the CRM application, associating a customer identity with the first person in the CRM application;
generating the output asking the first person for consent to map the user identity in the social interaction application with the customer identity in the CRM application;
receiving the consent from the person; and
in response to the consent, using the user identity in the social interaction application to communicate with the first person from the CRM application.

18. The computer program product of claim 14, further comprising:
creating a service ticket based on the data;
wherein the output includes information associated with the creation of the service ticket.

19. A system comprising:
a social media server comprising a social interaction application that allows third party access to communications;
a customer relationship management (CRM) server comprising a CRM application; and
an integrated social media and CRM system operative to
receive, in the CRM application, data from a communication made by a first person using the social interaction application;
assign, based on the data, a sentiment indicator to the communication according to a predefined scale; and
generate at least one output to the first person using the CRM application in response to receiving the data, the output based on the sentiment indicator.

20. The system of claim 19, wherein the communication is related to a predetermined business and was made over a predetermined period of time, and wherein the integrated social media and CRM system is further operative to:
receive, in the CRM, more data from one or more other communications made by one or more other persons in the social interaction application, wherein each of the other communications is related to the predetermined business and was made over the predetermined period of time;
assign, based on the more data, respective sentiment indicator to each of the other communications accordingly to the predetermined scale;
determine a sentiment index for the predetermined business using the sentiment indicator and each respective sentiment indicator; and
generate on a display device, a visual display that shows visual representations of the sentiment index over the predetermined period of time.
